(19) United States
(12) Patent Application Publication
(10) Pub. No.: US 2015/0116203 A1
(43) Pub. Date: Apr. 30, 2015

(54) IMAGE PROCESSING APPARATUS, IMAGE PROCESSING METHOD, AND PROGRAM

(71) Applicant: SONY CORPORATION, Tokyo (JP)

(72) Inventors: Tomoya Narita, Kanagawa (JP); Shuichi Konami, Chiba (JP)

(21) Appl. No.: 14/391,497

(22) PCT Filed: Apr. 8, 2013
(86) PCT No.: PCT/JP2013/002392

§ 371 Date: Oct. 9, 2014

(30) Foreign Application Priority Data
Jun. 7, 2012 (JP) 2012-129680

(51) Int. Cl. G06F 3/01; G06T 5/00

(52) U.S. Cl. CPC G06F 3/013; G06T 5/002; G06T 5/003; G06T 5/008; G06T 2207/20208; G06T 2207/20192
USPC 345/156

(57) ABSTRACT

An apparatus includes a receiver configured to receive from a detector a location of a gazing point of a user on an image, and an image processor configured to perform an adjustment process to adjust visual characteristics of the image based on the location of the gazing point of the user on the image.

### TECHNICAL FIELD

The present disclosure relates to an image processing apparatus, an image processing method, and a program encoded on a non-transitory computer readable medium. The present disclosure contains subject matter related to that disclosed in Japanese Priority Patent Application JP 2012-129680 filed in the Japan Patent Office on Jun. 7, 2012, the entire content of which is hereby incorporated by reference.

### BACKGROUND ART

In recent years, image content such as a photograph, movie or recorded program has been able to be reproduced and easily enjoyed with such things as a home television or personal computer, a photo stand, a smart phone, a portable terminal, a game machine, or a tablet terminal.

Further, in the near future, display control in accordance with the sight line of a user will be performed, by using a sensor which detects the sight line of the user who is looking at a display screen. For example, technology is presented in [PTL 1], in the case where a plurality of images (objects) are displayed side by side at the same time, which controls a display position of each object so that the plurality of objects can be confirmed at a glance, based on the sight line of the user.

### CITATION LIST

### Patent Literature

PTL 1: JP 2009-251303A

### SUMMARY

### Technical Problem

Here, there are two visual field regions, a “central view” and a “peripheral view”, in the visual field of a human. Of these, the “central view” is a visual field region received by the central fovea and which has a high resolution and superior sense of color. On the other hand, the “peripheral view” is a region surrounding the central view, and while it has a high sensitivity of brightness compared to that of the central view, the reproducibility of the sense of color is inferior. Note that the region close to the central point of the visual field of the user is called a “central view region”, and the visual field region capable of being recognized by the peripheral view of the user is called a “peripheral view region”.

In this way, while a central view of human eyes has characteristics such as a sense of color superior to that of a peripheral view and a low sensitivity of brightness, there is nothing described in [PTL 1] with respect to performing an image process which supplements such characteristics of human eyes when displaying image content such as a photograph or moving image.

Accordingly, the present disclosure proposes a new and improved image processing apparatus, image processing method, and program, which is capable of performing an effective image process which considers the characteristics of human eyes.

### Solution to Problem

The present invention broadly comprises an apparatus, a method, and a nontransitory computer readable medium encoded with a program that causes a computer to perform the method. In one embodiment, the apparatus includes a receiver configured to receive from a detector a location of a gazing point of a user on an image, and an image processor configured to perform an adjustment process to adjust visual characteristics of the image based on the location of the gazing point of the user on the image.

### Advantageous Effects of Invention

According to the embodiment of the present disclosure as described above, an effective image process can be performed which considers the characteristics of human eyes.

### BRIEF DESCRIPTION OF DRAWINGS

FIG. 1 is a figure for describing an outline of an image processing system according to the embodiments of the present disclosure.

FIG. 2 is a block diagram which shows a configuration of a display device according to the embodiments of the present disclosure.

FIG. 3 is a flow chart which shows the operation processes of the image processing system according to the embodiments of the present disclosure.

FIG. 4 is a figure for describing an image process according to a first embodiment.

FIG. 5 is a figure which shows an example of a plurality of pieces of image content, which differ in luminance, used in a luminance adjustment of an HDR.

FIG. 6 is a figure for describing a luminance adjustment of an HDR at the time of gazing at a whiteout region according to a second embodiment.

FIG. 7 is a figure for describing a luminance adjustment of an HDR at the time of gazing at a blackout region according to the second embodiment.

FIG. 8 is a figure for describing the reproduction of light adaptation according to a third embodiment.

FIG. 9 is a figure for describing an outline adjustment by sight line detection according to a fourth embodiment.

FIG. 10 is a figure for describing subtitle display by sight line detection according to a fifth embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In this specification and the appended drawings, there may be some cases where structural elements that have substantially the same function and structure are distinguished by denoting a different character or numeral after the same reference numerals. However, in cases where there is there may be no have to particularly distinguish each of the structural elements that have substantially the same function and structure, only the same reference numerals may be denoted.

Further, the present disclosure will be described according to the order of items shown below.

1. Basic items of the image processing system

1-1 Outline

1-2 Configuration of the display device

1-3 Operation processes

2. Each of the embodiments

2-1 The first embodiment

2-2 The second embodiment

2-3 The third embodiment

2-4 The fourth embodiment

2-5 The fifth embodiment

3. Conclusion

Further, the technology according to the embodiment of the present disclosure can be implemented in various forms, as described in detail in “2-1. The first embodiment” to “2-5. The fifth embodiment” as examples. Further, a display device 1 according to each of the embodiments including the functions of an image processing apparatus includes: A. an identification section (11) which specifies a gazing point of a user in displayed image content, and B. an image processing section (13) which performs a luminance adjustment of the displayed image content by using a plurality of pieces of image content, which differ in luminance, in accordance with the identified gazing point.

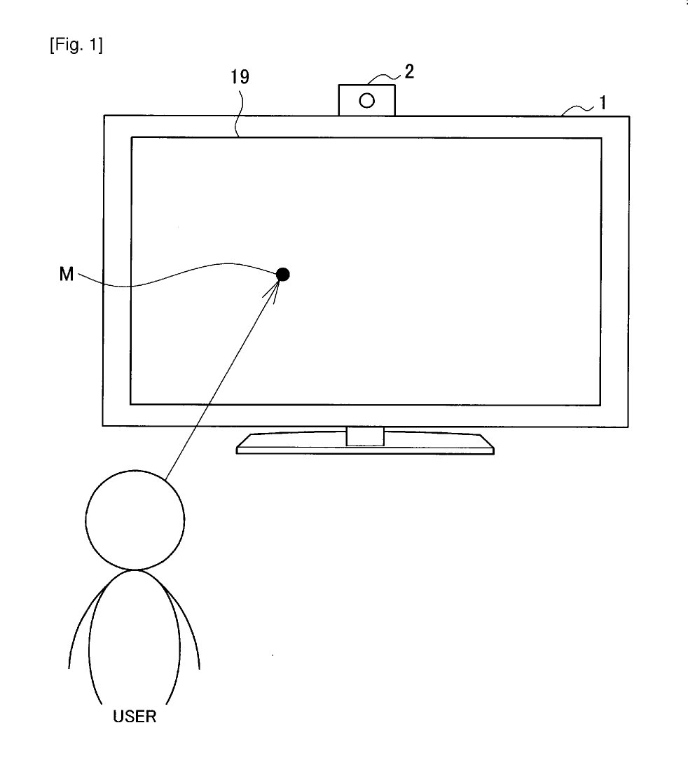

Hereinafter, first the basic items of such an image processing system, common to each of the embodiments, will be described with reference to FIGS. 1 to 3.

### 1. BASIC ITEMS OF THE IMAGE PROCESSING SYSTEM

### 1-1. Outline

FIG. 1 is a figure for describing an outline of an image processing system according to the embodiments of the present disclosure. As shown in FIG. 1, an image processing system according to the embodiments of the present disclosure includes a display device 1 and a sensor for sight line detection 2.

As shown in FIG. 1, the display device 1 includes a display section 19 on which image content such as still images or moving images are displayed. The display device 1 specifies a gazing point M of a user who is looking at the display section 19, based on a detection result by the sensor 2. Further, the display device 1 performs an image process so as to more effectively express the image content, according to the gazing point M.

The sensor for sight line detection 2 includes such things as a camera for detecting direction, movement or the like of the user's pupils, and a device for measuring the distance to the user. The display device 1 specifies a central point (hereinafter, called a gazing point) M of the sight line of the user who is looking at the display section 19, based on information (a detection result) from these parts of the sensor 2.

Here, as described above, a central view of human eyes has characteristics such as a sense of color superior to that of a peripheral view, and a low sensitivity of brightness.

Accordingly, the point of view of this situation led to creating the display device 1 according to each of the embodiments of the present disclosure. The display device 1 according to each of the embodiments of the present disclosure is capable of performing an effective image process which considers the characteristics of human eyes, by performing an image process according to a gazing point of a user. Hereinafter, a configuration of such a display device 1, common to each of the embodiments of the present disclosure, will be described.

Note that while FIG. 1 shows the display device 1 as an example of an image processing apparatus according to the embodiment of the present disclosure, the image processing apparatus according to the embodiment of the present disclosure is not limited to such an example. For example, the image processing apparatus according to the embodiment of the present disclosure may be an information processing apparatus, such as a PC (Personal Computer), a household video processing apparatus (such as a DVD recorder or a VCR), PDA (Personal Digital Assistants), an HMD (Head Mounted Display), a household game device, a mobile phone, a portable video processing apparatus, or a portable game device. Further, the image processing apparatus according to the embodiment of the present disclosure may be a display installed in a movie theater or a public location.

### 1-2. Configuration of the Display Device

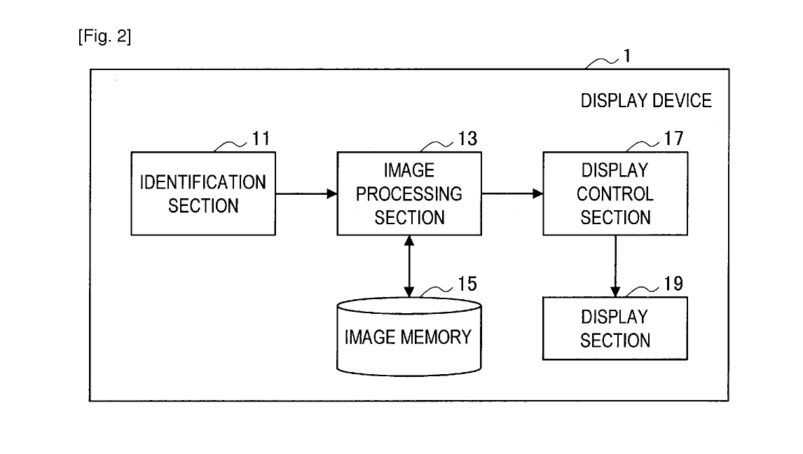

FIG. 2 is a block diagram which shows a configuration of the display device 1 according to the embodiments of the present disclosure. As shown in FIG. 2, the display device 1 according to a first embodiment includes an identification section 11, an image processing section 13, an image memory 15, a display control section 17, and a display section 19.

(Identification Section)

The identification section 11 specifies a gazing point M of the sight line of the user who is looking at the display section 19, based on information (a detection result) from the sensor 2. The identification section 11 outputs position information of the identified gazing point M to the image processing section 13.

(Image Processing Section)

The image processing section 13 performs an image process such as luminance adjustment for the image content displayed on the display section 19, according to the position of the gazing point M identified by the identification section 11. In this case, the image processing section 13 may perform an image process by using image content stored in the image memory 15 in advance or image content generated based on the displayed image content. Note that the pieces of content of the specific image process by the image processing section 13 will be described in detail in “2. Each of the embodiments”.

(Image Memory)

The image memory 15 is a storage section which stores image content such as a photograph or video (recorded program, movie or video). Further, the image content used for the image process by the image processing section 13 (for example, image content which differs in luminance from the original image content) may be stored in the image memory 15 in advance.

(Display Control Section)

The display control section 17 controls the display section 19 so as to display the image content to which luminance adjustment has been performed by the image processing section 13.

(Display Section)

The display section 19 displays the image content in accordance with the control of the display control section 17. Further, the display section 19 is implemented, for example, by an LCD (Liquid Crystal Display) or an OLED (Organic Light-Emitting Diode).

### 1-3. Operation Processes

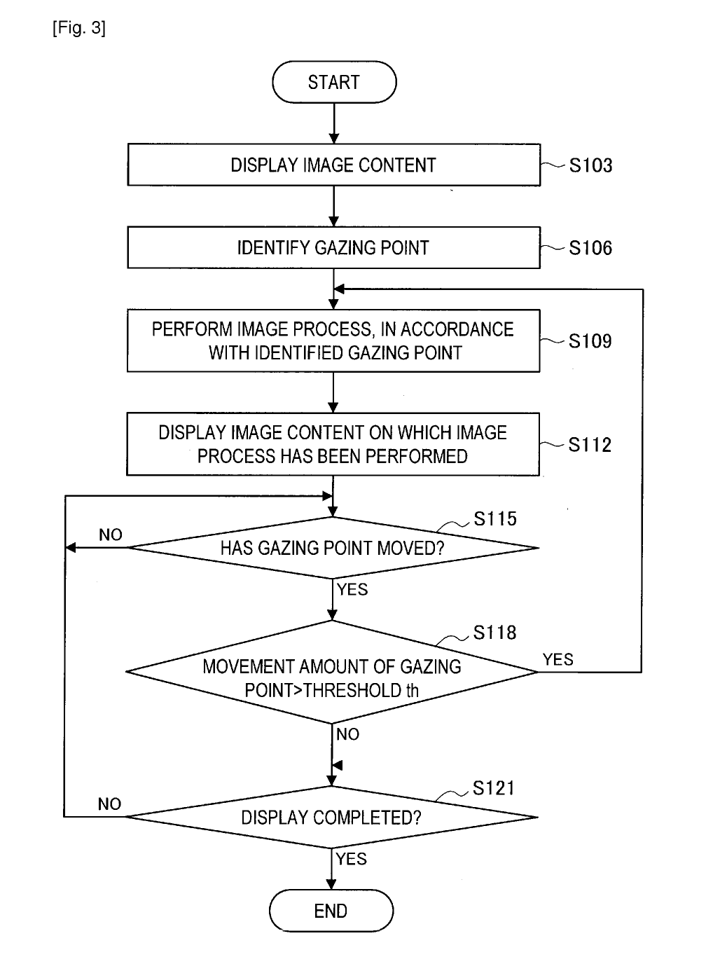

Next, the operation processes of the image processing system according to the embodiments of the present disclosure will be described with reference to FIG. 3.

FIG. 3 is a flow chart which shows the operation processes of the image processing system according to the embodiments of the present disclosure. As shown in FIG. 3, first in step S103, the display section 19 displays the image content stored in the image memory 15 in accordance with the control of the display control section 17.

Next, in step S106, the identification section 11 specifies a gazing point M of a user who is looking at the display section 19, based on information detected by the sensor 2.

Next, in step S109, the image processing section 13 performs an image process of the displayed image content, according to the gazing point identified by the identification section 11. Here, the image processing section 13 may perform the image process by using image content stored in the image memory 15 in advance, or may perform the image process by using image content generated based on the displayed image content. For example, the image processing section 13 performs an image process in the image content, such as adjusting the luminance of a part corresponding to the gazing point M of the user to be higher than the luminance of the surroundings, or optimizing the contrast of the part corresponding to the gazing point M of the user.

Next, in step S112, the display control section 17 controls the display section 19 so as to display the image content on which the image process has been performed. In this way, the display device 1 according to the present embodiment performs a luminance adjustment according to the gazing point M of the user, and can more effectively express the image content.

Next, in step S115, the image processing section 13 judges whether or not the position of the gazing point M, which is continuously identified by the identification section 11, has moved.

Next, in step S118, in the case where the gazing point M has moved (S115/Yes), the image processing section 13 judges whether or not the movement amount of the gazing point M has exceeded a threshold th.

To continue, in the case where the movement amount of the gazing point M has exceeded the threshold th (S118/Yes), in step S109, the image processing section 13 again performs an image process according to the gazing point M.

Then, in step S121, the display device 1 judges whether or not the display of the image content has been completed, and repeats the above described processes of S109 to S118 until it is completed.

Heretofore, the basic items according to the embodiments of the present disclosure have been described in detail. To continue, the image process in accordance with the gazing point M of the image processing section 13 shown above in step S109 will be specifically described by using the following plurality of embodiments.

### 2. EACH OF THE EMBODIMENTS

### 2-1. The First Embodiment

As described above, a central view of human eyes has characteristics such as a sense of color superior to that of a peripheral view and a low sensitivity of brightness, or the peripheral view has characteristics such as a sensitivity of brightness higher than the central view and an inferior sense of color vision. In order to supplement these characteristics, the image processing section 13 according to the first embodiment performs an image process in the image content, which increases the luminance of a part corresponding to a central view region centered on the gazing point M of the user, and increases the saturation of a peripheral view region. In this way, the display device 1 according to the present embodiment can present an image, in which the vividness of the entire image content has been secured, while securing the brightness of a central part of the visual field of the user (central view region).

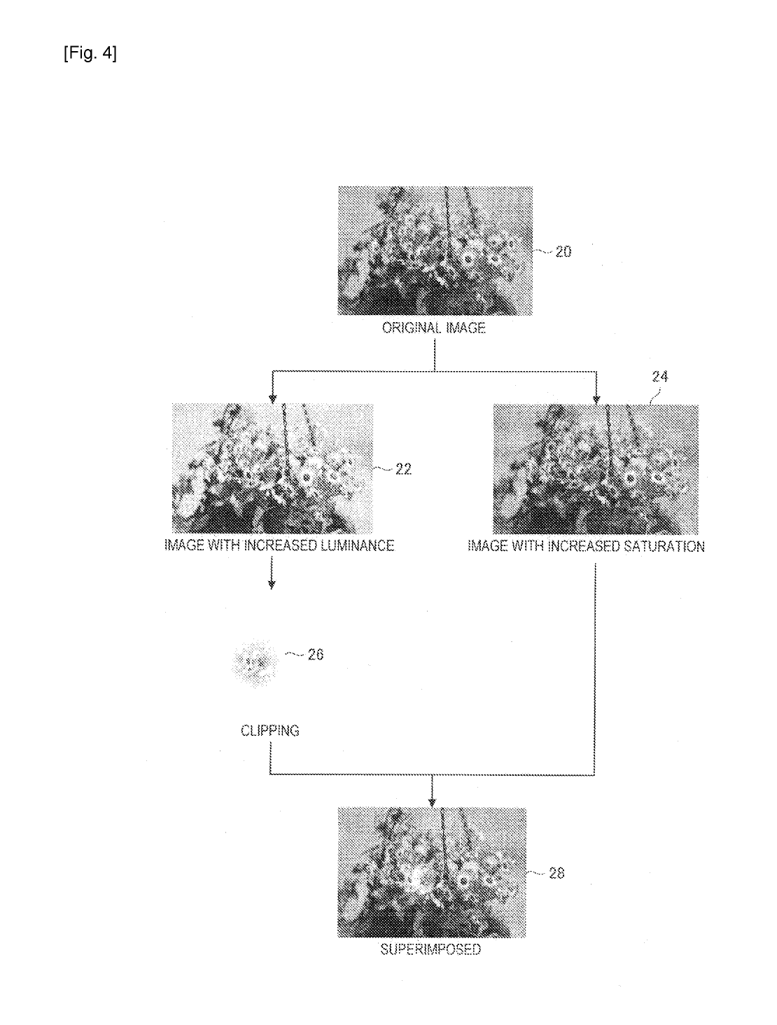

While the implementation method of such an image process according to the first embodiment is not particularly limited, the image processing section 1, for example, may be implemented by the method as shown in FIG. 4.

FIG. 4 is a figure for describing an image process according to the first embodiment. As shown in FIG. 4, in the case where there is original image content 20 (for example, photograph data), the image processing section 13 first generates an image content 22 in which the luminance has been increased more than that of the original image 20, and an image content 24 in which the saturation has been increased more than that of the original image 20. Note that the image processing section 13 may generate each of the pieces of image content 22 and 24 used in the image process in advance and store them in the image memory 15, or may generate each of the pieces image content 22 and 24 during the image process.

Next, the image processing section 13 arranges a clipping mask, which has a circular shape and a blurred outline, around a position corresponding to the gazing point M of the user in the image content 22 with increased luminance, clips the image content 22, and as shown in FIG. 4, acquires a clipped image 26. Note that the radius of the clipping mask may be set, in proportion to the distance (visually recognized distance) from the user to the display section 19, so that the radius lengthens as the visually recognized distance shortens. Note that the shape of the clipping mask is not limited to a circular shape. Further, the size of the clipping mask may be approximately the same size as the central view region of the user.

Next, as shown in FIG. 4, the image processing section 13 generates an image content 28 by superimposing the clipped image 26 around the position corresponding to the gazing point M of the user in the image content 24 with increased saturation. Such a generated (luminance or saturation adjusted) image content 28 makes the part corresponding to the central view region, which is centered on the gazing point M of the user, have luminance higher than that of the original image content 20, and makes the part corresponding to the peripheral view region have saturation higher than that of the original image content 20.

In this way, the display device 1 according to the present embodiment can supplement the characteristics of human eyes, such as the central view having a sensitivity of brightness lower than that of the peripheral view, or the peripheral view having a sense of color inferior to that of the central view. That is, the display device 1 can present to the user an image content 28, in which the brightness of the central view region and the saturation of the peripheral view region have been secured.

Note that, as described above, since the processes of steps S109 to S118 shown in FIG. 3 are continuously performed, it is possible for the image processing section 13 to update in real time the part in the image content 28 to which the brightness has been secured, according to the sight line movement of the user (movement of the gazing point M).

### 2-2. The Second Embodiment

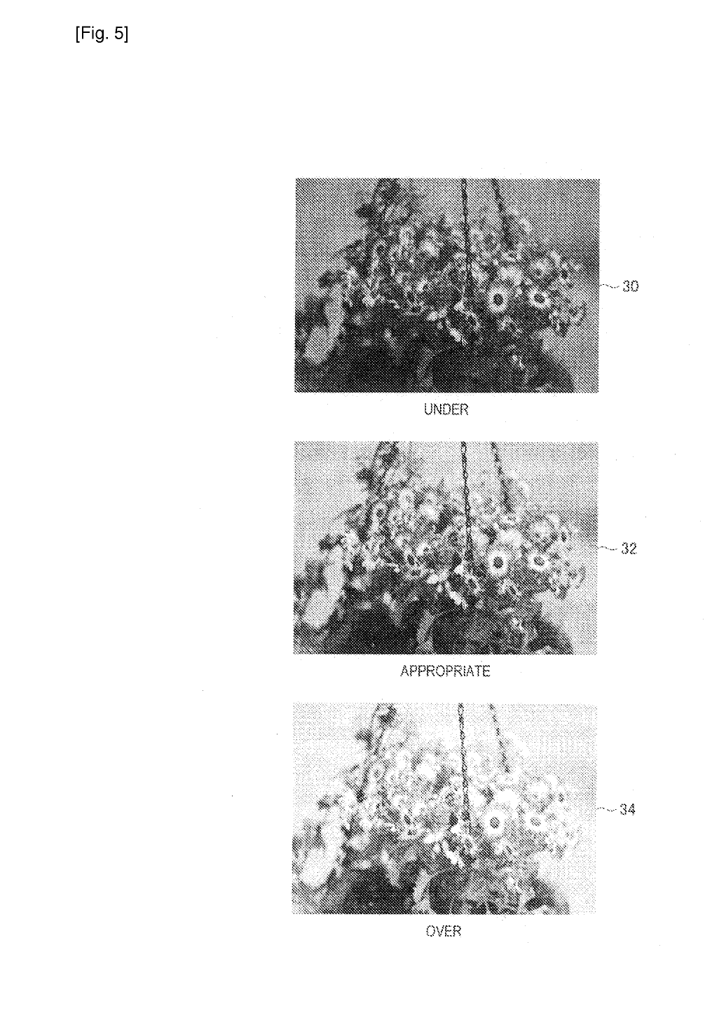

Next, optimization of the contrast in accordance with the gazing point of the user, in a high dynamic composite image, will be described. Usually, when a high dynamic composite image is generated, as shown in FIG. 5, appropriately exposed image content 32, under-exposed image content 30 which has a luminance level lower than appropriate, and over-exposed image content 34 which has a luminance level higher than appropriate, are used. Note that such pieces of image content 30 to 34 are continuously shot by changing the exposure sensitivity during photographing (high dynamic range photographing).

In usual high dynamic composition, whiteout regions and blackout regions are calculated within the appropriately exposed image content 32, and the under-exposed image content 30 and over-exposed image content 34 are applied to the whiteout regions and the blackout regions, respectively. In this way, in high dynamic composition, the dynamic range of the entire image content (hereinafter, called a High Dynamic Range HDR) is processed so as to fall within a constant range.

However, in usual high dynamic composition, the entire contrast is lowered in order to suppress the HDR of the entire image content to within a constant range, and since it becomes a special expression with an increased contrast for each part, it will be inferior to the real state and unnatural.

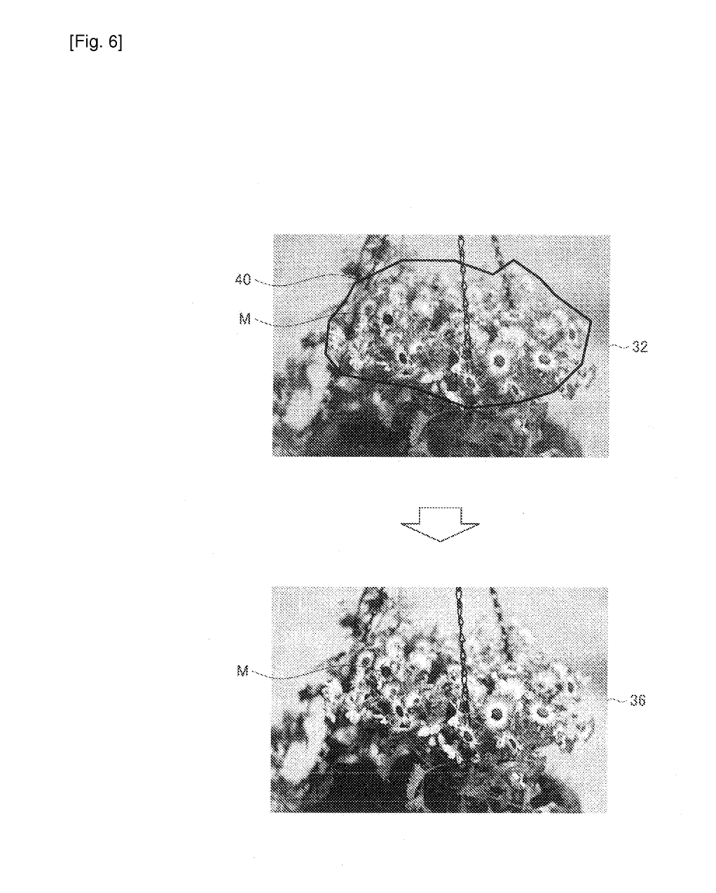

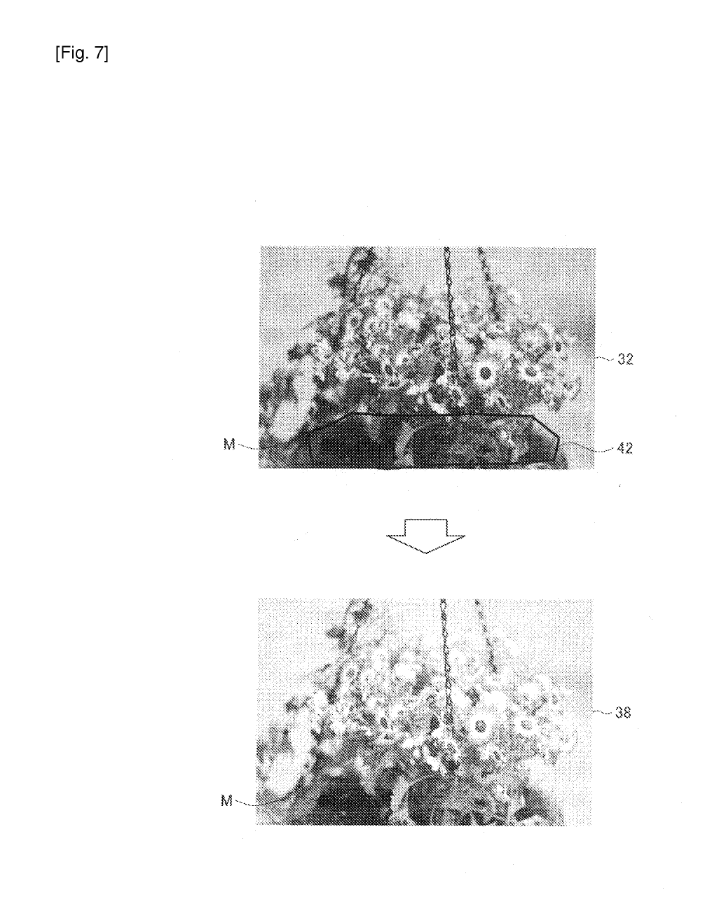

Accordingly, the image processing section 13 according to a second embodiment can express a dynamic range more naturally while securing the dynamic range, by performing a luminance adjustment of the entire image content so as to secure the contrast of the central view region, according to the gazing point of the user. Hereinafter, luminance adjustment of the HDR, in accordance with the gazing point of the user, according to the second embodiment will be specifically described with reference to FIGS. 6 to 7.

First, in the luminance adjustment of the HDR according to the present embodiment, the plurality of pieces of image content 30 to 34, which differ in luminance as shown in FIG. 5, are used, and these pieces of image content may be stored in the image memory 15 in advance.

(In Gazing at a Whiteout Region)

FIG. 6 is a figure for describing a luminance adjustment of the HDR at the time of gazing at a whiteout region according to the second embodiment.

As shown in the upper part of FIG. 6, in the case where the position corresponding to the gazing point M of the user identified by the identification section 11 is within a range of a whiteout region 40 in the appropriately exposed image content 32, the image processing section 13 performs a luminance adjustment by using the under-exposed image content 30.

More specifically, the image processing section 13 optimizes the contrast of the image content, based on the image content 30 which has luminance lower than that of the appropriately exposed image content 32. In this way, the periphery of the gazing point M of the user (central view region) becomes expressed more naturally, such as in the image content 36 shown in the lower part of FIG. 6.

Note that the gazing point M on the image content 36 is shown for the convenience of the description, and is not actually shown in the case where the image content 36 is displayed on the display section 19.

Further, in the case where the contrast of the image content is optimized based on the image content 30 with low luminance, while it is possible for a dark part to have additional blackout, as shown in the image content 36 of FIG. 6, since there is no part which the user is gazing at, there will be no particular influence.

Further, the image processing section 13 may direct the display control section 17 so as to switch the display to the image content 30 with low luminance itself, in addition to the image content 36 to which contrast optimization has been performed based on the image content 30 with low luminance.

(In Gazing at a Blackout Region)

FIG. 7 is a figure for describing a luminance adjustment of the HDR at the time of gazing at a blackout region according to the second embodiment.

As shown in the upper part of FIG. 7, in the case where the position corresponding to the gazing point M of the user identified by the identification section 11 is within a range of a blackout region 42 in the appropriately exposed image content 32, the image processing section 13 performs a luminance adjustment by using the over-exposed image content 34.

More specifically, the image processing section 13 optimizes the contrast of the image content, based on the image content 34 which has luminance higher than that of the appropriately exposed image content 32. In this way, the periphery of the gazing point M of the user (central view region) becomes expressed more naturally, such as in the image content 38 shown in the lower part of FIG. 7.

Note that the gazing point M on the image content 38 is shown for the convenience of the description, and is not actually shown in the case where the image content 38 is displayed on the display section 19.

Further, in the case where the contrast of the image content is optimized based on the image content 34 with high luminance, while it is possible for a light part to have additional whiteout, as shown in the image content 38 of FIG. 7, since there is no part which the user is gazing at, there will be no particular influence.

Further, the image processing section 13 may direct the display control section 17 so as to switch the display to the image content 34 with high luminance itself, in addition to the image content 38 to which contrast optimization has been performed based on the image content 34 with high luminance.

As described above, the image processing section 13 according to the present embodiment performs respectively an appropriate luminance adjustment, according to whether the gazing point M of the user is positioned in either the whiteout or blackout region in the appropriately exposed image content 32. Further, the image processing section 13 according to the present embodiment may perform a histogram adjustment so as to optimize the contrast in the periphery of the gazing point M, and an unnatural composition is not necessary for suppressing the entire image in a constant dynamic range.

Note that, as described above, since the processes of steps S109 to S118 shown in FIG. 3 are continuously performed, it is possible for the image processing section 13 to perform a luminance adjustment of the HDR in real time, according to the sight line movement of the user (movement of the gazing point M).

### 2-3. The Third Embodiment

Next, more effective image content is presented in a third embodiment of the present disclosure, by performing a luminance adjustment so as to express light adaptation/dark adaptation in a moving image.

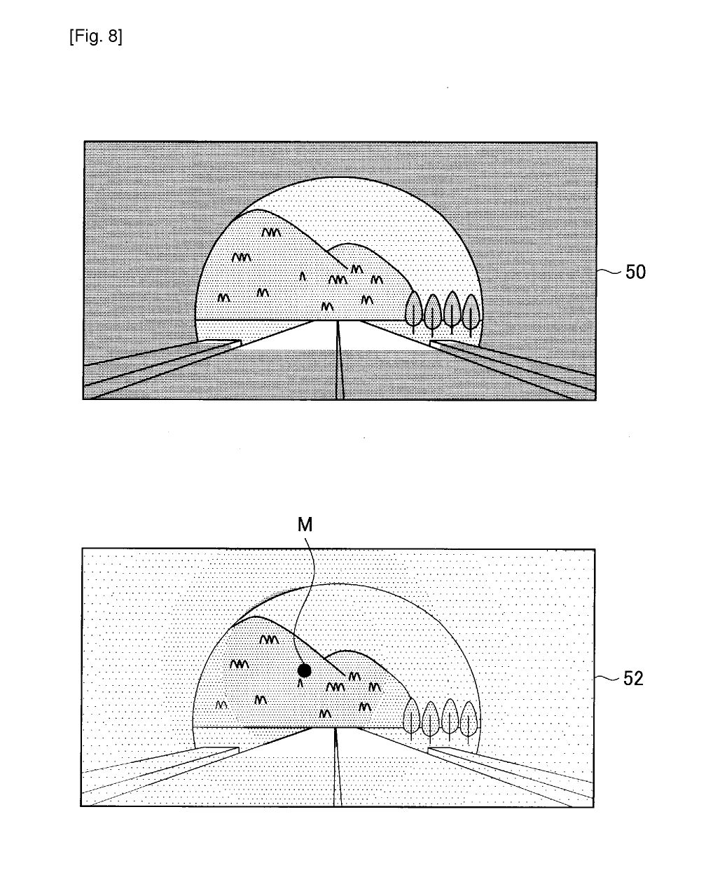

For example, in the case where a situation of exiting from within a dark tunnel to a bright outside is photographed, such as in the image 50 shown in the upper part of FIG. 8, usually the inside of the tunnel appears dark, and the outside appears bright. However, when actually photographing, an extreme glare is sensed from the outside light, and there are cases where light adaptation, in which the visibility gradually recovers, is generated, and this glare is not sensed in the image 50.

Accordingly, in the case where luminance equal to or more than a predetermined value, or a rapid light change of the outside light, is sensed during photographing, the display device 1 according to the present embodiment can implement a natural expression closer to that of the real state, by reproducing a light adaptation during regeneration.

Note that the image processing section 13 may judge, for reproducing light adaptation in a frame within a moving image, whether or not light change information, which shows, for example, luminance equal to or more than a predetermined threshold or a rapid light change of the outside light being sensed, is associated with the frame within the moving image.

Specifically, in the case where a frame with associated light change information is reproduced, such as in the image 52 shown in the lower part of FIG. 8, the image processing section 13 performs a luminance adjustment so as to remarkably increase (equal to or more than a predetermined value) the luminance of the peripheral view region, with the surroundings of the identified gazing point M (central view region) left as the original image.

In this way, the user who is looking at the image 52 senses an extremely bright stimulus in the peripheral view region, and can continue viewing the central view region while sensing a high luminous intensity within the range of luminance to which the image 52 displayed on the display section 19 has been limited.

In this way, the image processing section 13 according to the present embodiment can express glare by remarkably increasing the luminance of the region in the image content corresponding to the peripheral view region, based on the gazing point M of the user. Further, the image processing section 13 can reproduce a light adaptation by performing the process so that the remarkably increased luminance gradually returns to the original luminance.

Note that while reproducing a light adaptation is described in FIG. 8, it is possible for the display device 1 according to the present embodiment to reproduce a dark adaptation in a similar way. Specifically, in the case where dark change information is associated with a frame within a moving image, when this frame is reproduced, the image processing section 13 can express darkness by remarkably decreasing the luminance of the region of the image content corresponding to the peripheral view region, based on the gazing point M of the user. Further, the image processing section 13 can reproduce a dark adaptation by performing the process so that the remarkably decreased luminance gradually returns to the original luminance.

### 2-4. The Fourth Embodiment

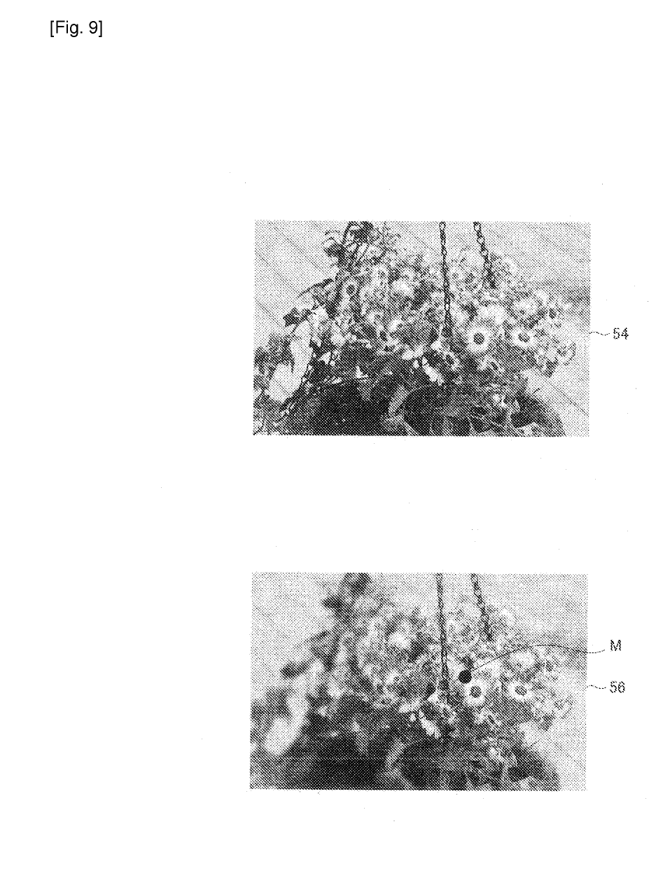

Next, an outline adjustment by sight line detection will be described as a fourth embodiment with reference to FIG. 9. FIG. 9 is a figure for describing an outline adjustment by sight line detection according to the fourth embodiment.

Usually, while an image outline in the central view region of the user becomes easy to see when it is clearly (a brightness difference is large) displayed, when an image outline in the peripheral view region is also clearly displayed, the user will feel fatigued. For example, in the case where an outline of a large part within the image is displayed clearly, such as in the image 54 shown in the upper part of FIG. 9, it is easy for a viewer to feel fatigued.

Accordingly, the image processing section 13 according to the present embodiment performs an outline adjustment by applying a sharpness filter to the central view region and a blur filter to the peripheral view region, such as in the image 56 shown in the lower part of FIG. 9, according to the identified gazing point M. In this way, since the image 56 can be presented with the outline of the central view region displayed clearly and the outline of the peripheral view region blurred, fatigue at the time of viewing can be prevented for the user.

Note that, as described above, since the processes of steps S109 to S118 shown in FIG. 3 are continuously performed, it is possible for the image processing section 13 to perform an outline adjustment in real time, according to the sight line movement of the user (movement of the gazing point M).

Further, the image processing section 13 may arrange an image content to which a blur filter has been applied in advance to the entire image content, and an image content to which a sharpness filters has been applied in advance to the entire image content, based on the original image content (for example, the image 54 shown in FIG. 9), and may store the pieces of image content in the image memory 15. In this case, the image processing section 13, similar to the procedure shown in FIG. 4, may clip the image in the central view region centered on the gazing point M of the user from the image content to which the sharpness filter has been applied, and may superimpose the clipped image on the image content to which the blur filter has been applied.

### 2-5. The Fifth Embodiment

Next, a subtitle display by sight line detection will be described as a fifth embodiment according to the embodiment of the present disclosure.

Usually, while additional information such as subtitles are displayed when viewing content of a foreign language or the like, when gazing at the original content, there are cases of flickering in the peripheral of the sight line, and this becomes a disturbance for viewing.

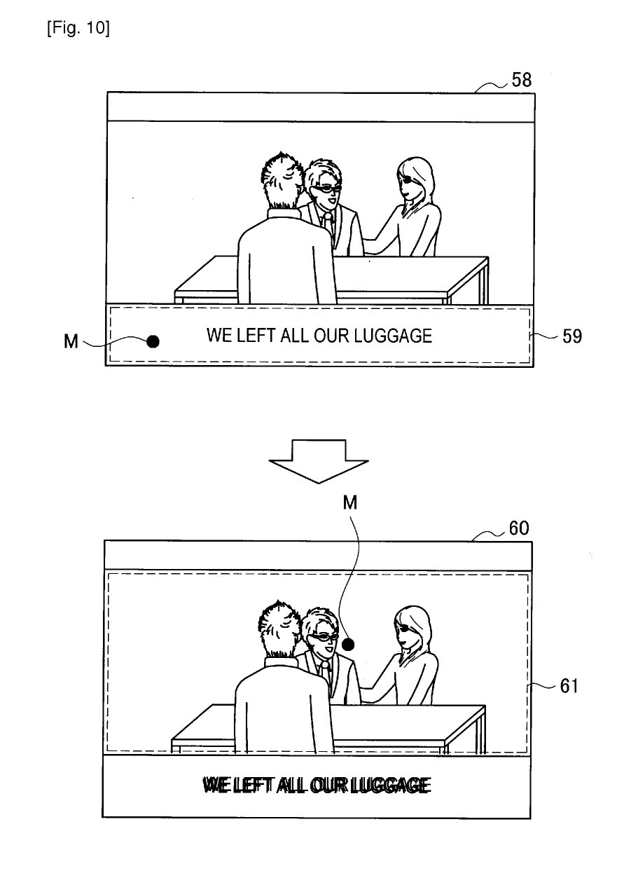

On the other hand, the image processing section 13 according to the present embodiment can prevent the display of subtitles or the like from becoming a disturbance in the case of gazing at the original content, by performing a process so that the display of additional information such as subtitles switches, according to the gazing point M of the user. Hereinafter, subtitle display switching according to the present embodiment will be specifically described with reference to FIG. 10.

In the case where the gazing point M of the user is included in a subtitle region 59, such as in the image 58 shown in the upper part of FIG. 10, the image processing section 13 performs usual subtitle display. Next, in the case where the gazing point M of the user is included in a content region 61, such as in the image 60 shown in the upper part of FIG. 10, the image processing section 13 performs a process so as to switch the subtitles to a dark/blurred display. Further, the image processing section 13 may use a fade in/fade out display when performing switching between the usual subtitle display and the dark/blurred display.

In this way, when the user is gazing at the content, the subtitle display can be prevented from flickering in the peripheral of the sight line.

### 3. CONCLUSION

According to the embodiments of the present disclosure as described above, an effective image process can be performed which considers the characteristics of human eyes.

Specifically, according to the first embodiment, for example, an image can be presented, in which the vividness of the entire image content has been secured, while securing the brightness of a central part of the visual field of the user (central view region), according to the gazing point of the user.

Further, according to the second embodiment, a dynamic range can be expressed more naturally while securing the dynamic range, by performing a luminance adjustment of the entire image content so as to secure the contrast of the central view region, according to the gazing point of the user.

Further, according to the third embodiment, when a predetermined frame is displayed in a moving image, a light adaptation/dark adaptation can be reproduced by performing a luminance adjustment so as to remarkably increase (equal to or more than a predetermined value) or decrease the luminance of the peripheral view region, according to the gazing point of the user.

Further, according to the fourth embodiment, a reduction in fatigue at the time of viewing can be implemented, and more effective content can be presented, by blurring an outline of the image displayed in the peripheral view region, according to the gazing point of the user.

Further, according to the fifth embodiment, in the case of gazing at a content region, a subtitle display or the like can be prevented from flickering in the peripheral of the sight line, by displaying the display of additional information such as subtitles as dark/blurred.

It should be understood by those skilled in the art that various modifications, combinations, sub-combinations and alterations may occur depending on design requirements and other factors insofar as they are within the scope of the appended claims or the equivalents thereof.

For example, in a display device which performs 3D display, the entire protruding amount/depth amount may be controlled according to the gazing point M of the user. Specifically, the image processing section 13 according to this embodiment controls the entire protruding amount/depth amount so that an object S, which is displayed at a position corresponding to the gazing point M, is positioned in a reference plane (display surface) (so that a parallax error between an image for the right eye and an image for the left eye of the object S becomes 0).

In this way, the load on the user's eyes can be reduced by having the protruding amount of the object S (which the user is gazing at) corresponding to the gazing point M become 0, or a protruding/depth sense from another object can be presented in the peripheral view region of the user.

Further, a computer program for causing hardware, such as a CPU, ROM and RAM built-into the display device 1, to exhibit functions similar to each configuration of the above described display device 1 can be created. Further, a non-transitory storage medium storing this computer program can also be provided.

Additionally, the present technology may also be configured as below.

(1)

An image processing apparatus, including: an identification section which identifies a gazing point of a user in displayed image content; and

an image processing section which performs a luminance adjustment of the displayed image content by using a plurality of pieces of image content that differ in luminance, in accordance with the identified gazing point.

(2)

The image processing apparatus according to (1), wherein, in a case where the identified gazing point has changed, the image processing section performs the luminance adjustment again according to a size of the change.

(3)

The image processing apparatus according to (1) or (2), wherein, in a case where the gazing point has moved for a distance equal to or more than a predetermined value, the image processing section performs the luminance adjustment again.

(4)

The image processing apparatus according to any one of (1) to (3), wherein the image processing section performs an adjustment in a manner that luminance of a central view region in which the identified gazing point is a center is higher than luminance of a peripheral view region, and saturation of the peripheral view region is higher than saturation of the central view region.

(5)

The image processing apparatus according to (4), wherein the image processing section adjusts luminance and saturation of the displayed image content, by cutting out an image around the gazing point, by using a clipping mask with a blurred outline, from first image content with luminance higher than luminance of original image content, and by superimposing the cut out image on the gazing point in second image content with saturation higher than saturation of the original image content.

(6)

The image processing apparatus according to any one of (1) to (3), wherein the image processing section adjusts the luminance of the image content, based on a state of an image region corresponding to the gazing point.

(7)

The image processing apparatus according to (6), wherein, in a case where the gazing point is positioned within a whiteout region, the image processing section adjusts the luminance of the image content, based on image content with luminance lower than the luminance of the image content.

(8)

The image processing apparatus according to (6), wherein, in a case where the gazing point is positioned within a blackout region, the image processing section adjusts the luminance of the image content, based on image content with luminance higher than the luminance of the image content.

(9)

The image processing apparatus according to any one of (1) to (3), wherein the displayed image content is a moving image, and wherein, in a case where light change information is assigned to a predetermined frame in a moving image, the image processing section performs an adjustment in a manner that luminance around a visual field in which the gazing point is a center is higher than a predetermined value.

(10)

The image processing apparatus according to any one of (1) to (3), wherein the displayed image content is a moving image, and wherein, in a case where dark change information is assigned to a predetermined frame in a moving image, the image processing section performs an adjustment in a manner that luminance around a visual field in which the gazing point is a center is lower than a predetermined value.

(11)

The image processing apparatus according to any one of (1) to (10), further including: a display section; and a display control section which controls the display section to display the image content on which a luminance adjustment has been performed by the image processing section.

(12)

The image processing apparatus according to (11), wherein the display section is a head mounted display.

(13)

An image processing method, including: identifying a gazing point of a user in displayed image content; and performing a luminance adjustment of the displayed image content by using a plurality of pieces of image content that differ in luminance, in accordance with the identified gazing point.

(14)

A program for causing a computer to execute the processes of: identifying a gazing point of a user in displayed image content; and performing a luminance adjustment of the displayed image content by using a plurality of pieces of image content that differ in luminance, in accordance with the identified gazing point.

(15)

An apparatus including:

a receiver configured to receive from a detector a location of a gazing point of a user on an image; and
an image processor configured to perform an adjustment process to adjust visual characteristics of the image based on the location of the gazing point of the user on the image.

(16)

The apparatus according to (15), wherein the image processor performs the adjustment process to adjust visual characteristics including at least one of a saturation, a contrast, a luminance, and a sharpness of the image.

(17)

The apparatus according to (15), wherein the image processor performs a first adjustment process on the image near the location of the gazing point of the user, and performs a second adjustment process on the image away from the location of the gazing point of the user.

(18)

The apparatus according to (17), wherein the image processor performs the first adjustment process including increasing the luminance of the image near the location of the gazing point of the user, and performs the second adjustment process including increasing the saturation of the image away from the location of the gazing point of the user.

(19)

The apparatus according to (17), wherein the image processor performs the first adjustment process including applying a sharpness effect to the image near the location of the gazing point of the user, and performs the second adjustment process including applying a blur effect to the image away from the location of the gazing point of the user.

(20)

The apparatus according to (15), wherein the image processor performs a first adjustment process when the location of the gazing point of the user is within a first portion of the image, and performs a second adjustment process when the location of the gazing point of the user is within a second portion of the image.

(21)

The apparatus according to (20), wherein the image processor performs the first adjustment process including adjusting the luminance of the image using data having a luminance less than the image when the first portion is a light portion of the image.

(22)

The apparatus according to (20), wherein the image processor performs the second adjustment process including adjusting the luminance of the image using data having a luminance greater than the image when the second portion is a dark portion of the image.

(23)

The apparatus according to (20), wherein the image processor performs the first adjustment process including darkening or blurring subtitles in the second portion, and performs the second adjustment process including brightening or sharpening subtitles in the second portion.

(24)

The apparatus according to (15), wherein the image processor performs the adjustment process on the image only away from the location of the gazing point of the user on the image.

(25)

The apparatus according to (24), wherein the image processor performs a luminance enhancement process on the image only away from the location of the gazing point of the user on the image.

(26)

A method including: receiving from a detector a location of a gazing point of a user on an image; and performing an adjustment process to adjust visual characteristics of the image based on the location of the gazing point of the user on the image.

(27)

The method according to (26), wherein the performing includes adjusting visual characteristics including at least one of a saturation, a contrast, a luminance, and a sharpness of the image.

(28)

The method according to (26), wherein the performing includes performing a first adjustment process on the image near the location of the gazing point of the user, and performing a second adjustment process on the image away from the location of the gazing point of the user.

(29)

The method according to (28), wherein the performing includes performing the first adjustment process including increasing the luminance of the image near the location of the gazing point of the user, and performing the second adjustment process including increasing the saturation of the image away from the location of the gazing point of the user.

(30)

The method according to (28), wherein the performing includes performing the first adjustment process including applying a sharpness effect to the image near the location of the gazing point of the user, and performing the second adjustment process including applying a blur effect to the image away from the location of the gazing point of the user.

(31)

The method according to (26), wherein the performing includes performing a first adjustment process when the location of the gazing point of the user is within a first portion of the image, and performing a second adjustment process when the location of the gazing point of the user is within a second portion of the image.

(32)

The method according to (31), wherein the performing includes performing the first adjustment process including adjusting the luminance of the image using data having a luminance less than the image when the first portion is a light portion of the image.

(33)

The method according to (31), wherein the performing includes performing the second adjustment process including adjusting the luminance of the image using data having a luminance greater than the image when the second portion is a dark portion of the image.

(34)

The method according to (31), wherein the performing includes performing the first adjustment process including darkening or blurring subtitles in the second portion, and performing the second adjustment process including brightening or sharpening subtitles in the second portion.

(35)

The method according to (26), wherein the performing includes performing the adjustment process on the image only away from the location of the gazing point of the user on the image.

(36)

A non-transitory computer readable medium encoded with computer readable instructions that, when performed by a processor, cause the processor to perform a method including:

receiving from a detector a location of a gazing point of a user on an image; and
performing an adjustment process to adjust visual characteristics of the image based on the location of the gazing point of the user on the image.

### REFERENCE SIGNS LIST

1 Display device
2 Sensor
11 Identification section
13 Image processing section
15 Image memory
17 Display control section
19 Display section
20 Original image content
22 Image content with increased luminance
24 Image content with increased saturation
26 Clipped image
28 Luminance/saturation adjusted image content
30 Under-exposed image content
32 Appropriately exposed image content
34 Over-exposed image content
36, 38 Image content
50 Usual image
52 Image with a reproduced light adaptation
54 Usual image
56 Image with a blurred outline of the peripheral view region
59 Subtitle region
61 Content region

1. An apparatus comprising:
a receiver configured to receive from a detector a location of a gazing point of a user on an image; and
an image processor configured to perform an adjustment process to adjust visual characteristics of the image based on the location of the gazing point of the user on the image.

2. The apparatus according to claim 1, wherein the image processor performs the adjustment process to adjust visual characteristics including at least one of a saturation, a contrast, a luminance, and a sharpness of the image.

3. The apparatus according to claim 1, wherein the image processor performs a first adjustment process on the image near the location of the gazing point of the user, and performs a second adjustment process on the image away from the location of the gazing point of the user.

4. The apparatus according to claim 3, wherein the image processor performs the first adjustment process including increasing the luminance of the image near the location of the gazing point of the user, and performs the second adjustment process including increasing the saturation of the image away from the location of the gazing point of the user.

5. The apparatus according to claim 3, wherein the image processor performs the first adjustment process including applying a sharpness effect to the image near the location of the gazing point of the user, and performs the second adjustment process including applying a blur effect to the image away from the location of the gazing point of the user.

6. The apparatus according to claim 1, wherein the image processor performs a first adjustment process when the location of the gazing point of the user is within a first portion of the image, and performs a second adjustment process when the location of the gazing point of the user is within a second portion of the image.

7. The apparatus according to claim 6, wherein the image processor performs the first adjustment process including adjusting the luminance of the image using data having a luminance less than the image when the first portion is a light portion of the image.

8. The apparatus according to claim 6, wherein the image processor performs the second adjustment process including adjusting the luminance of the image using data having a luminance greater than the image when the second portion is a dark portion of the image.

9. The apparatus according to claim 6, wherein the image processor performs the first adjustment process including darkening or blurring subtitles in the second portion, and performs the second adjustment process including brightening or sharpening subtitles in the second portion.

10. The apparatus according to claim 1, wherein the image processor performs the adjustment process on the image only away from the location of the gazing point of the user on the image.

11. The apparatus according to claim 10, wherein the image processor performs a luminance enhancement process on the image only away from the location of the gazing point of the user on the image.

12. A method comprising:
receiving from a detector a location of a gazing point of a user on an image; and
performing an adjustment process to adjust visual characteristics of the image based on the location of the gazing point of the user on the image.

13. The method according to claim 12, wherein the performing includes adjusting visual characteristics including at least one of a saturation, a contrast, a luminance, and a sharpness of the image.

14. The method according to claim 12, wherein the performing includes performing a first adjustment process on the image near the location of the gazing point of the user, and performing a second adjustment process on the image away from the location of the gazing point of the user.

15. The method according to claim 14, wherein the performing includes performing the first adjustment process including increasing the luminance of the image near the location of the gazing point of the user, and performing the second adjustment process including increasing the saturation of the image away from the location of the gazing point of the user.

16. The method according to claim 14, wherein the performing includes performing the first adjustment process including applying a sharpness effect to the image near the location of the gazing point of the user, and performing the second adjustment process including applying a blur effect to the image away from the location of the gazing point of the user.

17. The method according to claim 12, wherein the performing includes performing a first adjustment process when the location of the gazing point of the user is within a first portion of the image, and performing a second adjustment process when the location of the gazing point of the user is within a second portion of the image.

18. The method according to claim 17, wherein the performing includes performing the first adjustment process including darkening or blurring subtitles in the second portion, and performing the second adjustment process including brightening or sharpening subtitles in the second portion.

19. The method according to claim 12, wherein the performing includes performing the adjustment process on the image only away from the location of the gazing point of the user on the image.

20. A non-transitory computer readable medium encoded with computer readable instructions that, when performed by a processor, cause the processor to perform a method comprising:
receiving from a detector a location of a gazing point of a user on an image; and
performing an adjustment process to adjust visual characteristics of the image based on the location of the gazing point of the user on the image.
